(19) United States
(12) Patent Application Publication
(10) Pub. No.: US 2014/0029144 A1
(43) Pub. Date: Jan. 30, 2014

(54) ESD PROTECTIVE CIRCUIT

(71) Applicant: KABUSHIKI KAISHA TOSHIBA, Tokyo (JP)

(72) Inventor: Daichi KAKU, Kanagawa (JP)

(73) Assignee: KABUSHIKI KAISHA TOSHIBA, Tokyo (JP)

(21) Appl. No.: 13/784,535

(22) Filed: Mar. 4, 2013

(30) Foreign Application Priority Data
Jul. 24, 2012 (JP) 2012-163574

(51) Int. Cl. H02H 9/04

(52) U.S. Cl. CPC H02H 9/04
USPC 361/56

(57) ABSTRACT

Circuit protecting against electrostatic discharge (ESD) includes a bias circuit connected in between a first power terminal and a second power terminal. The bias circuit includes a resistor circuit and a diode circuit. The diode circuit comprises multiple diodes connected in series. During ESD protective operation, the bias circuit supplies a bias terminal with a clamping voltage that is higher than the ordinary power supply voltage. The bias terminal is connected to a driver circuit including at least one inverter circuit. Depending on the voltage of the bias terminal and the voltage of the first power terminal, the driver circuit controls the conduction state of a shunt transistor by supplying a voltage to the gate electrode of the shunt transistor.

### CROSS-REFERENCE TO RELATED APPLICATION

This application is based upon and claims the benefit of priority from Japanese Patent Application No. 2012-163574, filed Jul. 24, 2012; the entire contents of which are incorporated herein by reference.

### FIELD

The embodiments described herein relate to an ESD protective circuit that can protect against surge currents during power-up and is able to set the starting voltage of the ESD protective operation.

### BACKGROUND

Recently, various circuits for protecting against electrostatic discharge (ESD) have been proposed. ESD is an electrical discharge caused by, for example, human or machine charging due to static electricity building-up and discharging onto, for example, a semiconductor device, or a charged semiconductor device. When a semiconductor device experiences an ESD discharge, a massive amount of electrical charge enters the semiconductor device and that electrical charge generates high voltages within the semiconductor device, causing interior components to breakdown and the device to malfunction. Because of this, inclusion of ESD protective circuits is an essential technology for semiconductor integrated circuits.

One existing ESD protective circuit is the RC trigger MOS (RCTMOS) circuit, which involves connecting a serial circuit of resistors and capacitors between the power terminals, using the voltage at the junction points of those resistors and capacitors as the trigger voltage to drive shunt MOS transistors. However, RCTMOS circuits respond during an ordinary power-up process and have problems with surge currents (inrush currents) during power-up that flow through the shunt MOS transistors. In addition, in order to increase the RC time constants by increasing capacitance, the area of the required capacitors may become large, leading to an increase in chip area. It has been proposed that bias circuits should be structured with a series circuit of resistors and diodes to handle the start-up surge currents.

However, with conventional technology, an ESD protective circuit that can easily set the starting voltage of ESD protective operation and prevent surge currents during power-up is not available.

### DESCRIPTION OF THE DRAWINGS

FIG. 1 illustrates an ESD protective circuit according to a first embodiment.

FIG. 2 illustrates an ESD protective circuit according to a second embodiment.

FIG. 3 illustrates an ESD protective circuit according to a third embodiment.

FIG. 4 illustrates an ESD protective circuit according to a fourth embodiment.

FIG. 5 illustrates an ESD protective circuit according to a fifth embodiment.

FIG. 6 illustrates an ESD protective circuit according to a sixth embodiment.

### DETAILED DESCRIPTION

Embodiments described herein provide an ESD protective circuit that does not respond to power-up of ordinary power supply voltage but operates when the voltage of the power terminal exceeds an arbitrarily set clamping voltage by a designated threshold value.

In general, embodiments of the present disclosure will be explained below with reference to the attached drawings, but the present disclosure is not limited to these example embodiments.

According to an embodiment, an electrostatic discharge (ESD) protective circuit includes a first power terminal supplied with a first power supply voltage and a second power terminal supplied with a second power supply voltage less than the first power supply voltage. A first transistor circuit (shunt transistor) is connected between the first and second power terminals. The protective circuit has a bias circuit, connected between the first and second power terminals, which supply a clamping voltage that is higher than the first power supply voltage. The bias circuit includes a resistor circuit and a diode circuit, each connected to a bias terminal. The clamping voltage is supplied at a bias terminal. The protective circuit also includes a driver circuit connected between the first and second power terminals. The driver circuit has an input terminal connected to the bias terminal and an output terminal connected to a gate electrode of the first transistor. The driver circuit includes at least one inverter circuit.

According to an embodiment, a bias circuit that generates a clamping (clamp) voltage set higher than the ordinary power supply voltage is connected between the power terminals. A shunt MOS transistor that has a source/drain channel connected in between the power terminals; when the power supply voltage is increased by the ESD exceeding the clamping voltage, the drive circuit operates and controls the conduction state of shunt MOS transistor, and shunt operation starts.

### First Embodiment

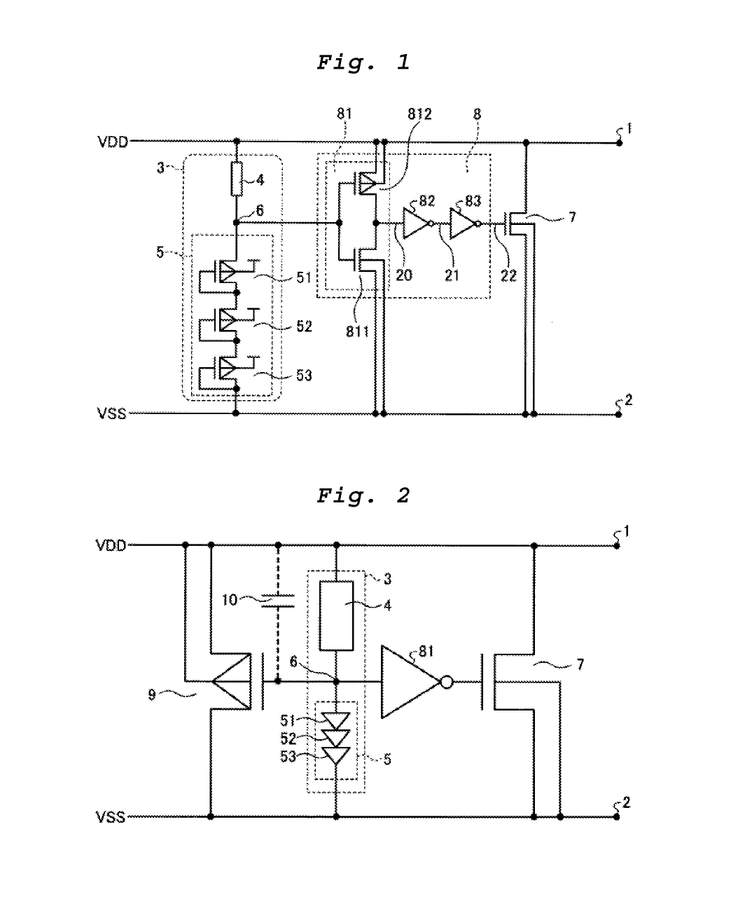

FIG. 1 depicts an ESD protective circuit according to a first embodiment. A bias circuit 3 is connected in between a first power terminal 1 and a second power terminal 2. The first power terminal 1 is impressed with the high-potential side voltage VDD, and the second power terminal 2 is impressed with the low-potential side voltage VSS.

The bias circuit 3 contains a bias terminal 6 which outputs the designated bias voltage. The bias circuit 3 includes a resistor 4 that is connected in between the first power terminal 1 where the high-potential side first voltage VDD is impressed and the bias terminal 6, and a diode circuit 5 that is connected in between the bias terminal 6 and the second power terminal 2 where the low-potential side second voltage VSS is impressed. The diode circuit 5 is connected in the forward direction to the power supply voltage and includes multiple diodes composed of PMOS transistors with a gate and drain connected together. In FIG. 1, three diodes 51 to 53 are shown as representatives.

The bias circuit 3 contains a designated clamping voltage. This clamping voltage is set higher than the ordinary power supply voltage VDD. This is to avoid surge currents from occurring when the ESD protective circuit is operated by the application of ordinary power supply voltage during power-up. The voltage of the bias terminal 6, i.e. the clamping voltage is the voltage where the threshold value set by the diode circuit 5 is added to the low-potential side voltage VSS as the reference, represented as (VSS+N×Vth). Having the low-potential side voltage VSS as the grounding electric potential, clamping voltage becomes (N×Vth), and can be set by the number of diodes N. For instance, when the first power supply voltage VDD is 2.5 V, the number of diodes may be set so that the clamping voltage becomes 2.8 V. Generally, the threshold value Vth of the diode is approximately 0.7 V.

The bias terminal 6 is connected to the input of a drive circuit 8. The drive circuit 8 contains CMOS (complementary metal-oxide-semiconductor) inverters 81 to 83 of three stages (level 3). As shown in the structure of the CMOS inverter 81 as the representative, a CMOS inverter contains the PMOS transistor 812 and an NMOS transistor 811 where the gates are commonly connected and the source/drain channel is connected in between the first and the second power terminals 1 and 2. The output of the CMOS inverter 81 is supplied to a second level CMOS inverter 82, the output of the second level CMOS inverter 82 is supplied to the third level CMOS inverter 83.

The output of the drive circuit 8 is supplied to the gate of an NMOS shunt transistor 7. The drain of the NMOS shunt transistor 7 is connected to the first power terminal 1, and the source is connected to the second power terminal 2.

When ESD is generated at the power terminal 1 and the voltage of the power terminal 1 increases, the voltage of the bias terminal 6 also increases. If the voltage of the power terminal 1 exceeds the clamping voltage of the bias circuit 3, the voltage of the bias terminal 6 is clamped at the clamping voltage of the bias circuit 3. Due to the relationship of the voltage of the bias terminal 6, if the voltage of the power terminal 1 exceeds the clamping voltage by the threshold value of the PMOS transistor 812 that composes the CMOS inverter 81, then the PMOS transistor 812 becomes ON-state, and high-potential output voltage is outputted to a node 20. In other words, the low/high decision of the voltage of the bias terminal 6 is performed with accordance to the circuit threshold of the CMOS inverter 81, the output voltage as a result of that is outputted to the node 20. Although the clamping voltage of the bias terminal 6 is a sufficient voltage to turn the NMOS transistor 811 of the CMOS inverter 81 ON; because of ESD, the voltage of the first power terminal 1 is sufficiently large compared to the clamping voltage, due to the relationship of the voltage of the bias terminal 6, if the voltage of the first power terminal 1 minus the clamping voltage exceeds the threshold value of the CMOS inverter 81, then the CMOS inverter 81 outputs high-potential voltage to the node 20.

When the high-potential voltage of the node 20 is supplied to the CMOS inverter 82 on the next level, the CMOS inverter 82 outputs low-potential output voltage onto a node 21. Since the voltage of the node 21 is low-potential, the CMOS inverter 83 supplies the gate of the NMOS shunt transistor 7 with high-potential voltage. From this, the NMOS shunt transistor 7 becomes ON-state, the shunt operation by the NMOS shunt transistor 7 is performed. By the shunt operation, the protected circuit elements (not shown) connected in between the power terminals 1 and 2 are protected from breakdown by ESD.

According to the present embodiment, the starting voltage of the ESD protective circuit operation may be arbitrarily set by the clamping voltage of the bias circuit. By setting the clamping voltage of the bias circuit higher than the ordinary power supply voltage VDD, the operation of ESD protective circuit by the application of ordinary power supply voltage may be prevented, thus preventing surge current during power-up.

### Second Embodiment

FIG. 2 depicts an ESD protective circuit according to a second embodiment. Corresponding structures to the first embodiment will be shown with identical symbols. Serial connection of the resistor 4 and the diode circuit 5 which composes the bias circuit 3 is connected in between the first and the second power terminals 1 and 2. The CMOS inverter 81 of level 1 is connected in between the bias terminal 6 and the gate of the NMOS shunt transistor 7.

The present embodiment includes a PMOS shunt transistor 9 where the source is connected to the first power terminal 1, and the drain is connected to the second power terminal 2. The gate of the PMOS shunt transistor 9 is connected to the bias terminal 6. The capacitance 10 depicted in FIG. 2 (and other figures) that is connected in between the first power terminal 1 and the gate of the PMOS shunt transistor 9 is not an actual device element, but rather is intended to represent the parasitic capacitance of the PMOS shunt transistor 9.

If the voltage of the power terminal 1 exceeds the clamping voltage that appears on the bias terminal 6 set by the bias circuit 3 by the circuit threshold value of the CMOS inverter 81, the CMOS inverter 81 decides that the input voltage of the bias terminal 6 is low voltage, and supplies the NMOS shunt transistor 7 with high-potential voltage. From this, the NMOS shunt transistor 7 is turned ON and shunt operation is performed.

Similarly, if the power supply voltage of the power terminal 1 exceeds the voltage of the bias terminal 6 that is supplied to the gate of the PMOS shunt transistor 9 (that is, the designated clamping voltage) by the threshold value of the PMOS shunt transistor 9, then the PMOS shunt transistor 9 is also turned ON and performs shunt operation. That is, shunt operation is performed by both the NMOS shunt transistor 7 and the PMOS shunt transistor 9.

When the power supply voltage of the power terminal 1 starts to fall, the difference in voltage appears on the bias terminal 6 due to the parasitic capacitance 10. Because of this, the voltage of the bias terminal 6 decreases while the voltage difference between the power terminal 1 and the bias terminal 6 is maintained, and the ON-state of the NMOS shunt transistor 7 and the PMOS shunt transistor 9 is maintained. From this, the shunt operation of the NMOS shunt transistor 7 and the PMOS shunt transistor 9 continues, ESD protective operation will be performed more reliably.

Even in the present embodiment, the starting voltage of the ESD protective circuit operation may be arbitrarily set by the clamping voltage of the bias circuit 3. By setting the clamping voltage of the bias circuit 3 higher than the ordinary power supply voltage VDD, the operation of ESD protective circuit by the impression of ordinary power supply voltage VDD may be prevented, thus prevent surge current during power-up.

### Third Embodiment

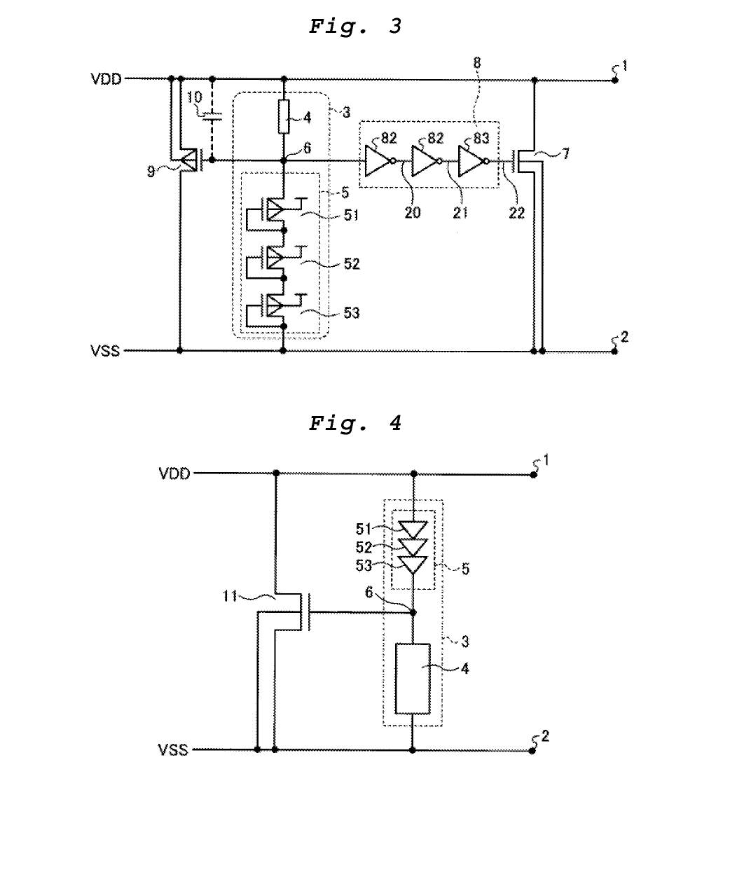

FIG. 3 depicts an ESD protective circuit according to a third embodiment. Corresponding structures to the first or the second embodiment will be shown with identical symbols. In this embodiment, the CMOS inverters 81 to 83 of level 3 are connected in between the bias terminal 6 and the gate of the NMOS shunt transistor 7. By appropriately setting the circuit threshold value of each of the CMOS inverters, the starting voltage of ESD operation may be adjusted, thus the degree of freedom of the design of the ESD protective circuit increases. In addition, by setting the number of CMOS inverter to an even number, PMOS shunt transistor may be used as the shunt transistor replacing the NMOS shunt transistor.

Even in the present embodiment, the starting voltage of the ESD protective circuit operation may be arbitrarily set by the clamping voltage of the bias circuit. By setting the clamping voltage of the bias circuit 3 higher than the ordinary power supply voltage VDD, the operation of ESD protective circuit by the impression of ordinary power supply voltage VDD may be prevented, thus prevent surge current during power-up.

### Fourth Embodiment

FIG. 4 depicts an ESD protective circuit according to a fourth embodiment. Corresponding structures to the first embodiment through the third embodiment will be shown with identical symbols. The bias circuit 3 connected in between the first power terminal 1 and the second power terminal 2 contains the diode circuit 5 connected in between the bias terminal 6 and the first power terminal 1, and the resistor 4 connected in between the bias terminal 6 and the second power terminal 2. The voltage of the bias terminal 6 is equivalent to the voltage when the voltage that appears on the power terminal 1 is Vdd, subtracted by the threshold value voltage set at the diode circuit 5; that is, clamped to (Vdd−N×Vth). Vth here is the diode threshold value; N represents the number of diodes being connected.

When the voltage of the power terminal 1 increases due to ESD and the voltage of the bias terminal 6 exceeds the threshold value of an NMOS shunt transistor 11, the NMOS shunt transistor 11 turns ON and shunt operation is performed. That is, if the voltage of the bias terminal 6 exceeds the threshold value Vthn of the NMOS shunt transistor 11 as the power supply voltage increases, the NMOS shunt transistor 11 turns ON and shunt operation starts. So when (Vdd−N×Vth)>(Vthn+VSS), in other words, when Vdd>(N×Vth+Vthn+VSS), shunt operation by the NMOS shunt transistor 11 starts.

The voltage of the power terminal 1 that starts the ESD protective operation may be set by the clamping voltage of the bias terminal 3. The voltage is equivalent to the voltage having the second power supply voltage VSS as its base, adding the threshold value (N×Vth) of the diode circuit 5 of the bias circuit 3 and the threshold value Vthn of the NMOS transistor 11; that is, by having (N×Vth+Vthn+VSS) set higher than the ordinary power supply voltage VDD, the NMOS shunt transistor 11 turning ON during power-up may be prevented, thus the generation of surge currents may be prevented.

### Fifth Embodiment

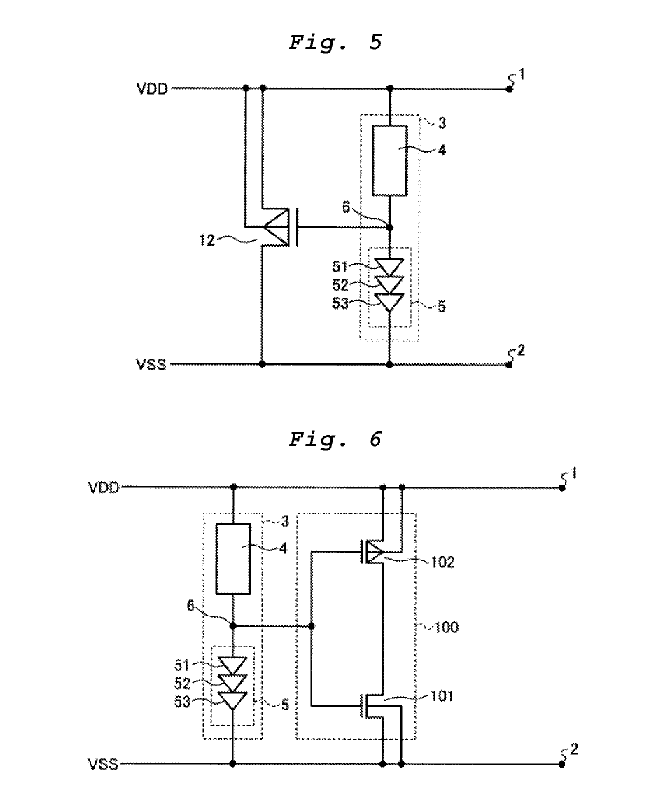

FIG. 5 depicts an ESD protective circuit according to a fifth embodiment. Corresponding structures to the first embodiment through the fourth embodiment will be shown with identical symbols. The bias circuit 3 connected in between the first power terminal 1 and the second power terminal 2 contains the resistor 4 connected in between the first power terminal 1 and the bias terminal 6, and the diode circuit 5 that contains multiple diodes 51 through 53 connected in between the bias terminal 6 and the second power terminal 2. A PMOS shunt transistor 12 where the first power terminal 1 is connected to the source, and the drain is connected to the second power terminal 2, has its gate connected to the bias terminal 6 of the bias circuit 3. The voltage of the bias terminal 6 is equivalent to the voltage when the power supply voltage VSS of the second power terminal 2 is added with the threshold value voltage set at the diode circuit 5; that is, clamped to (VSS+N×Vth). VSS is the voltage supplied to the second power terminal 2, generally called grounding electric potential; Vth is the threshold value of the diode in the diode circuit 5; N represents the number of diodes connected.

When the power supply voltage Vdd increases due to ESD and exceeds the voltage of the bias terminal 6 set by the bias circuit 3 by the threshold value Vthp of the PMOS shunt transistor 12, the PMOS shunt transistor 12 turns ON and shunt operation is performed. That is, when power supply voltage Vdd becomes Vdd>(N×Vth+Vthp+VSS), then shunt operation by the PMOS shunt transistor 12 is started. In other words, the voltage of the power terminal 1 to start the ESD operation may be set by the arbitrarily set clamp voltage (VSS+N×Vth) of the bias circuit 3. Now, the threshold value Vthp of the PMOS shunt transistor 12 is described as a positive value (Vthp>0).

The voltage is equivalent to the voltage having the power supply voltage VSS of the second power terminal 2 as its base, adding the threshold value (N×Vth) of the diode circuit 5 and the threshold value Vthp of the PMOS shunt transistor 12; that is, by having (N×Vth+Vthp+VSS) set higher than the ordinary power supply voltage VDD that is supplied to the first power terminal 1, the PMOS shunt transistor 12 turning ON during power-up may be prevented, thus the generation of surge currents may be prevented.

### Sixth Embodiment

FIG. 6 depicts an ESD protective circuit according to a sixth embodiment. Corresponding structures to the first embodiment through the fifth embodiment will be shown with identical symbols. The bias circuit 3 connected in between the first power terminal 1 and the second power terminal 2 contains the resistor 4 connected in between the first power terminal 1 and the bias terminal 6, and the diode circuit 5 that contains multiple diodes 51 through 53 connected in between the bias terminal 6 and the second power terminal 2. a CMOS inverter 100 is connected in between the first power terminal 1 and the second power terminal 2. The CMOS inverter 100 contains a PMOS transistor 102 and an NMOS transistor 101 where the gates are supplied with voltages of the bias terminal 6, and the source/drain channel is connected in between the first and the second power terminals 1 and 2.

The voltage of the bias terminal 6 is clamped to (VSS+N×Vth) by the bias circuit 3. Here, VSS is the voltage supplied to the second power terminal 2, Vth is the threshold value of the diodes connected in the diode circuit 5, and N is the number of diodes. The clamping voltage (VSS+N×Vth) of the bias terminal 6 is set to a higher value than the ordinary power supply voltage VDD.

By setting the circuit threshold value of the CMOS inverter 100 close to the clamping voltage of the bias circuit 3 that is, (VSS+N×Vth); when the power supply voltage increases and the voltage of the bias terminal 6 reaches the clamping voltage, the MOS transistors 101 and 102 that compose the CMOS inverter 100 turn ON simultaneously, through-current flows through the power terminals and shunt operation is performed. That is, an ESD protective circuit that can set the starting voltage of the ESD protective operation by the voltage set at the clamping voltage of the bias terminal 3 can be provided. By setting the clamping voltage of the bias circuit 3 to be higher than the ordinary power supply voltage VDD, surge current during power-up may be prevented during power-up.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An ESD protective circuit, comprising:
a first power terminal supplied with a first power supply voltage;
a second power terminal supplied with a second power supply voltage less than the first power supply voltage;
a first transistor connected between the first and second power terminals;
a bias circuit connected between the first and second power terminals, the bias circuit configured to supply a clamping voltage higher than the first power supply voltage to a bias terminal; and
a driver circuit connected between the first and second power terminals, the driver circuit having an input terminal connected to the bias terminal and an output terminal connected to a gate of the first transistor,
wherein the bias circuit includes a resistor circuit connected to the bias terminal and the first power terminal and a diode circuit connected to the bias terminal and the second power terminal, and
the driver circuit includes at least one inverter circuit.

2. The ESD protective circuit of claim 1, wherein the diode circuit comprises a plurality of diodes connected in series.

3. The ESD protective circuit of claim 2, wherein the relationship (VDD−VSS)<(N×Vth) is satisfied, when a threshold voltage value for each diode in the plurality of diodes is Vth, the number of diodes in the plurality is N, VDD is the first power supply voltage, and VSS is the second power supply voltage.

4. The ESD protective circuit of claim 1, wherein the diode circuit includes a PMOS-type transistor having a drain electrode connected to a gate electrode.

5. The ESD protective circuit of claim 1, further comprising:
a second transistor connected between the first and second power terminals, the second transistor having a gate electrode connected to the bias terminal.

6. The ESD protective circuit of claim 5, wherein the first transistor is a NMOS-type transistor and the second transistor is a PMOS-type transistor.

7. The ESD protective circuit of claim 1, wherein the drive circuit comprises a plurality of inverter circuits connected in series.

8. The ESD protective circuit of claim 7, wherein the inverter circuits are complementary metal-oxide-semiconductor (CMOS) inverter circuits.

9. The ESD protective circuit of claim 1, wherein the at least one inverter circuit comprises a PMOS-type transistor and a NMOS-type transistor.

10. The ESD protective circuit of claim 1, wherein the driver circuit includes an even number of inverter circuits, and the first transistor is a PMOS-type transistor.

11. An ESD protective circuit, comprising:
a first power terminal supplied with a first power supply voltage;
a second power terminal supplied with a second power supply voltage, and one of the first and second power supply voltage is less than the other power supply voltage;
a bias terminal;
a diode circuit including a plurality of diodes connected in a forward bias direction in series between the first power terminal and the bias terminal;
a resistor circuit connected between the bias terminal and the second power terminal; and
a MOS-type transistor having a drain electrode connected to the first power terminal, a source electrode connected to the second power terminal, and a gate electrode connected to the bias terminal,
the relationship (N×Vth+Vthm+VSS)>VDD being satisfied when a threshold voltage value of each diode in the plurality is Vth, where the number of diodes in the plurality is N, a threshold voltage value of the MOS transistor is Vthm, VDD is a higher voltage among the first and second power supply voltage, and VSS is a lower voltage among the first and second power supply voltage.

12. The ESD protective circuit of claim 11, wherein VDD is the first power supply voltage and VSS is the second power supply voltage less than the first power supply voltage, and the MOS-type transistor is an NMOS-type transistor.

13. The ESD protective circuit of claim 11, wherein VDD is the second power supply voltage and VSS is the first power supply voltage less than the second power supply voltage, and the MOS-type transistor is a PMOS-type transistor.

14. The ESD protective circuit of claim 11, wherein the threshold voltage value of each diode in the plurality is approximately 0.7 V.

15. An ESD protective circuit, comprising:
a first power terminal supplied with a first power supply voltage;
a second power terminal supplied with a second power supply voltage less than the first power supply voltage;
a bias terminal;
a resistor circuit connected between the first power terminal and the bias terminal;
a diode circuit including a plurality of diodes connected in a forward bias direction and in series between the bias terminal and the second power terminal;
an inverter circuit including a first transistor and a second transistor,
wherein a gate electrode of the first transistor is connected to the bias terminal, a gate electrode of the second transistor is connected to the bias terminal, and a source/drain channel of the first and second transistors is connected between the first power terminal and the second power terminal; and
the relationship (VSS+N×Vth)>VDD is satisfied when a threshold voltage value of each diode in the plurality is Vth, where the number of diodes in the plurality is N, VDD is the first power supply voltage, and VSS is the second power supply voltage.

16. The ESD protective circuit of claim 15, further comprising:
a third transistor connected between the first and second power terminals, and a gate electrode of the third transistor is connected to a terminal between the first and second transistors.

17. The ESD protective circuit of claim 15, wherein the first transistor is a PMOS-type transistor, and the second transistor is a NMOS-type transistor.

18. The ESD protective circuit of claim 15, wherein the inverter circuit is a complementary metal-oxide-semiconductor (CMOS) inverter circuit.

19. The ESD protective circuit of claim 15, wherein the diode circuit includes a PMOS-type transistor having a drain electrode connected to a gate electrode.

20. The ESD protective circuit of claim 15, wherein the first transistor is a PMOS-type transistor connected to the first power terminal, and the second transistor is a NMOS-type transistor connected to the second power terminal.
